(19) United States
(12) Patent Application Publication
(10) Pub. No.: US 2018/0304107 A1
(43) Pub. Date: Oct. 25, 2018

(54) PROTECTIVE SYSTEM FOR AIRCRAFT PILOT

(71) Applicant: Zodiac Aerotechnics, Plaisir (FR)

(72) Inventors: Pierre Juran, Alfortville (FR); Matthieu Fromage, Saint-Arnoult-en-Yvelines (FR); Frédéric Duranton, Paris (FR); Jérémy Jacotey, Croissy s/Seine (FR)

(73) Assignee: Zodiac Aerotechnics, Plaisir (FR)

(21) Appl. No.: 15/569,366

(22) PCT Filed: Apr. 27, 2016
(86) PCT No.: PCT/FR2016/050995

§ 371 Date: Oct. 25, 2017

Related U.S. Application Data
(60) Provisional application No. 62/241,797, filed on Oct. 15, 2015.
(60) Provisional application No. 62/242,671, filed on Oct. 16, 2015.

(30) Foreign Application Priority Data
Apr. 27, 2015 (FR) 15 00892

(51) Int. Cl. A62B 18/08; A62B 18/02; G02B 27/01

(52) U.S. Cl. CPC A62B 18/082; G08G 5/0021; G02B 27/0172; A62B 18/02

(57) ABSTRACT

A protective system for aircraft pilot comprises a breathing mask, an eye protection and a safety device. The breathing mask is designed to supply the pilot with a respiratory gas and the breathing mask comprises an oxygen supply duct intended to be connected to an aircraft cockpit. The eye protection comprises a screen intended to extend between the pilot's eyes and an external space. The safety device comprises a display device and a support. The display device is able to display, notably in front of a pilot's eye, information intended to assist in the piloting of the aircraft. The support carries the display device so as to keep the display of information in front of the pilot's eye.

### FIELD OF THE INVENTION

The invention relates to a protective system for an aircraft pilot, intended to assist the pilot by displaying information near his eye.

### BACKGROUND OF THE INVENTION

The invention aims to provide assistance to the pilot in difficult situations such as complex navigation, or conditions outside the aircraft cockpit or inside the aircraft cockpit (particularly fire/smoke) reducing the visibility of visual cues outside the aircraft and/or information displayed by the flight instruments inside the aircraft cockpit.

### DISCLOSURE OF THE INVENTION

For this purpose, according to the invention, the protective system comprises:

a breathing mask intended to supply the pilot with a respiratory gas, wherein said breathing mask comprises an oxygen supply duct intended to be connected to an aircraft cockpit,

an eye protection comprising a screen intended to sit between the pilot's eyes and an external space,

a safety device comprising a display device and a support,

the display device is able to display, notably in front of a pilot's eye, information intended to assist with piloting the aircraft, and

the support carries the display device so as to keep the display of information in front of the pilot's eye (within the field of vision).

Thus, the display device provides the pilot with visual information which could be difficult to obtain or could be obtained in a degraded manner. In addition, the protective system allows the pilot to keep both hands free to control the aircraft.

According to an optional feature of the invention, the display device preferably comprises an exterior virtual display displaying an exterior virtual view in the form of video originating either from an object detector, such as a camera that is preferably infrared, a radar, or a multispectral detector, in order to improve the pilot's vision, or recreated from a database.

Thus, the protective system in particular provides the pilot with external vision from the aircraft when weather conditions do not allow satisfactory direct vision, particularly a view of the runway in fog conditions. The exterior virtual display is sometimes referred to by the acronym EVS (Enhanced Vision System) or EFVS (Enhanced Flight Vision System).

According to another feature of the invention, the display device preferably comprises a symbol-based display displaying a representation using symbols of the flight data obtained from flight instruments.

Thus, the protective system provides the pilot in particular with a view of the flight data when conditions inside the aircraft do not allow the pilot to see the flight instruments or the screen representing the flight instruments.

According to an additional feature of the invention, the symbol-based display preferably comprises a graphics processing device adapted to receive quantitative values from flight instruments and to generate its own symbol-based display.

“Its own symbol-based display” is understood to mean a symbol-based display that is not provided by the flight instruments and is therefore different from the display of the flight instruments in the aircraft cockpit. The symbol-based display device thus allows adapting the representation of the flight data to the specific characteristics of a display near the pilot's eye, independent of the representation used to represent flight data on the instrument panel of the aircraft.

According to a complementary feature of the invention, the protective system preferably comprises a differentiated brightness adjustment for the exterior virtual display and the symbol-based display.

Pilot eyestrain is thus reduced while allowing the pilot to clearly distinguish the information essential to piloting.

According to another feature of the invention, the protective system preferably enables selecting the exterior virtual display and/or the symbol-based display.

The pilot is thus effectively assisted in piloting the aircraft by allowing him to select the information needed.

According to yet another feature of the invention, the symbol-based display displays a symbol-based representation of the flight data obtained from flight instruments, including an artificial horizon, an airspeed indicator, and an altimeter.

According to another feature of the invention, the display device advantageously displays the information in a single color, preferably green.

According to another feature of the invention, preferably the protective system further comprises at least one photodiode for measuring the ambient brightness, the display device has a variable display brightness, and the display brightness of the display device varies according to the ambient brightness measured by the photodiode.

Visibility of the information content provided to the pilot is thus improved.

According to an additional feature of the invention, the display device further has a display brightness setting, and the display brightness of the display device varies according to the display brightness setting and the ambient brightness.

Thus, the pilot can adjust the difference in brightness between the brightness of the display device and the ambient brightness, the display device keeping this difference constant.

According to an additional feature of the invention, preferably the protective system further comprises a storage system which saves the display brightness setting, the display device having an off state and an on state, and the storage system keeps the display brightness setting saved during both the off state and the on state of the display device.

According to another feature of the invention, preferably said display device is an emergency display device, the protective system further comprises a main display device able to display information on or near an aircraft windshield, the protective system further comprises a source of information, and said main display and said emergency display are both connected to said source of information.

Thus, depending on the conditions, the pilot can see the information on the main display or on the emergency device.

According to yet another feature of the invention, preferably the protective system further comprises an orientation sensing device able to determine the position of the support, and the orientation sensing device acts on the display device.

Thus, by detecting the orientation of the pilot's face, the protective system determines what information is of interest to the pilot and the displayed information is modified accordingly, which provides even more effective assistance to the pilot.

According to an additional feature of the invention, the orientation sensing device detects variations in orientation (rotation) of the support.

According to yet another additional feature, the display device displays information content and varies the orientation of the content relative to the support in a manner corresponding to the variations in orientation of the support.

Thus, the protective system moves the information content when the pilot turns his head, to give him the illusion that the information content is remaining in the same place. The protective system thus provides the pilot with a virtual reality and effectively assists him with piloting.

According to another feature of the invention, the orientation sensing device comprises at least one inertial device.

Preferably, the inertial device comprises an accelerometric device comprising a plurality of accelerometers or a gyroscopic device with one or preferably three axes.

According to another additional feature of the invention, preferably the orientation sensing means comprises a first inertial device connected to the support, a second inertial device intended to be connected to an aircraft, and a computing device to which the first inertial device and the second inertial device are connected, the computing device determining the orientation of the pilot's head based on information sent by the first inertial device and the second inertial device.

According to an alternative feature of the invention, the orientation sensing device comprises at least one optical device and an optical analysis device able to determine movements.

The optical device is preferably an infrared system or a camera and the optical analysis device is advantageously adapted to determine movement between two images or between an image and a frame of reference in the aircraft which may consist of a characteristic shape of the cabin, in particular the cockpit, or of reference marks provided for this purpose.

According to another feature of the invention, the orientation sensing device further comprises an image capture device and a captured image analysis device able to determine the direction of the pilot's gaze relative to the support.

Thus, the protective system takes into account the movements of the pilot's gaze when he is not moving his head, allowing better determination of the information useful to the pilot.

According to an additional feature of the invention, the orientation sensing device is preferably able to issue an instruction to turn off the display device.

Thus, when it is determined by the direction of the pilot's gaze that the pilot is not looking at the displayed information content, the display device is turned off.

According to another feature of the invention, preferably the display device displays essential information content and optional information content, and the orientation sensing device is able to issue an instruction to turn off or to display the optional information content.

Thus, when it is determined by the direction of the pilot's gaze that the pilot is rarely or never looking at the displayed information content, the amount of displayed information is reduced.

According to another feature of the invention, preferably the display device displays information content which can be varied in size, and the orientation sensing device is able to issue an instruction to vary the size of the information content.

Thus, when it is determined by the direction of the pilot's gaze that the pilot is rarely or never looking at the displayed information content, the size of the information content is reduced.

According to another feature of the invention, preferably the display device comprises a semi-reflective member and the display device comprises a projector projecting a light beam onto the semi-reflective member.

In addition, the display device may comprise an additional lens to focus the image. The shape of the semi-reflective member allows adjusting the focus distance.

According to an additional feature of the invention, the projector preferably comprises an emissive microdisplay.

According to yet another additional feature of the invention, the projector preferably comprises one or more light sources and a microdisplay modulating the light from the light source(s), in particular a microdisplay that is LCD (Liquid Crystal Display), LCOS (Liquid Crystal on Silicon), DMD (Digital Micromirror Device), DLP (Digital Light Processing), or the like.

According to another feature of the invention, the display device is preferably mounted so as to be movable relative to the support between an active position intended to be in front of a pilot's eye and a retracted position away from the pilot's eye.

Thus, when the pilot does not want to use the display device, the display does not obstruct the pilot's vision but remains readily available when needed.

According to an additional feature of the invention, the display device is preferably mounted on the support by means of a slide system or by means of connecting rods for moving the display device between the active position and the retracted position.

This solution is simple, robust, and easy to use.

According to another feature of the invention, the display device preferably lies in an internal space separated from the external space by the screen.

The display device is thus protected, in particular from ambient air that could reduce visibility of the displayed information.

According to an optional feature of the invention, the eye protection is adapted to be placed on the pilot's face around the eyes, the eye protection, and in particular the transparent screen, isolating from the external space the internal space between the eye protection and the eyes of the user.

The pilot's eyes are thus protected from the ambient air while having access to the information content provided by the display device.

According to an additional feature of the invention, preferably the protective system further comprises an adjustment device extending through the screen and able to move the display device.

Movement of the display device arranged in the internal space is thus easily controllable by the pilot.

According to an additional feature of the invention, preferably the adjustment device comprises a control knob for manually adjusting the positioning of the display device relative to the support along the interpupillary direction, and the control knob extends into the external space.

According to another additional feature, the adjustment device preferably comprises a screw-nut system.

According to yet another feature of the invention, the display device is preferably adapted to be positioned at a distance of at least 18 millimeters from the pilot's eyes, in order to be compatible with wearing eyeglasses (or sunglasses or similar).

The protective system is thus compatible with wearing eyeglasses between the display device and the pilot's face.

According to an alternative feature of the invention, preferably the display device is in the external space, near the screen.

According to an additional feature of the invention, preferably the screen has a hole or holes facing the display device.

Gas in the internal space can thus escape through the hole and travel around the display device, in order to allow the escape of smoke that may be present in the ambient air of the display device.

According to an additional feature of the invention, the hole or holes has (have) a total cross-sectional area preferably between 1 square millimeter and 1 square centimeter.

The flow of gas escaping through the hole thus carries smoke away from the display device in a satisfactory manner.

According to another additional feature of the invention, the display device is preferably situated at a distance of less than 10 mm, in particular less than 5 millimeters and preferably less than 2 millimeters, from the protective screen.

The flow of gas thus effectively carries smoke away from the display device.

According to another feature of the invention, the display device is preferably movably mounted relative to the support so as to move along an interpupillary direction.

The protective system thus allows the pilot to have a better and more comfortable view of the information content provided by the display device.

According to an additional feature of the invention, preferably the protective system comprises an adjustment device adapted to move the display device translationally along the interpupillary direction.

This easy to use and robust solution allows precise adjustment in the interpupillary direction.

According to another feature of the invention, the adjustment device comprises a rack.

According to another feature of the invention, the display device is preferably mounted relative to the support so as to be movable along an elevation direction.

According to an additional feature of the invention, the protective system preferably further comprises an adjustment device adapted to move the display device translationally relative to the support, along an elevation direction perpendicular to the interpupillary direction.

The protective system thus allows the pilot to have an even better and more comfortable view of the information content provided by the display device.

According to another feature of the invention, the protective system comprises two safety devices, each safety device being intended to enter the field of vision of each of the pilot's eyes.

The pilot thus has a better view of the information content provided.

According to another feature of the invention, preferably the eye protection is held in a releasable or retractable manner relative to the breathing mask.

The eye protection may thus be removed or retracted, for example in the manner of a motorcycle helmet chin guard or visor, when not needed.

According to an additional feature of the invention, preferably the eye protection is releasably attached to the breathing mask, the protective system comprises an electrical conductor intended to be connected to the aircraft cockpit, the electrical conductor comprises a first electrical connector, said display device is connected to a second electrical connector, and the first electrical connector is automatically electrically connected to the second electrical connector when the eye protection is attached to the breathing mask.

The eye protection can thus be easily attached to or released from the breathing mask.

According to another feature of the invention, preferably the breathing mask comprises a first mode wherein the breathing mask supplies respiratory gas to the pilot substantially at ambient pressure and a second mode (fire/smoke) wherein the breathing mask provides respiratory gas to the pilot at a pressure higher than ambient pressure, and the safety device comprises an active mode and an inactive mode.

The pilot is thus protected against the intrusion of ambient gas into the breathing mask.

According to a complementary feature of the invention, the safety device is preferably automatically placed in active mode when the second mode of the breathing mask is selected.

The pilot thus has only one action to take in order to be protected against the intrusion of ambient gas into the breathing mask and to be able to access the information content provided by the display device.

Conversely, according to the invention, the safety device is preferably placed automatically in inactive mode when the second mode of the breathing mask is not selected.

According to another feature of the invention, preferably the transition from active mode to inactive mode includes shutting down the display device, in particular the transition from active mode to inactive mode preferably includes moving the support from the active position in front of the pilot's eye to the retracted position away from the pilot's eye.

Thus, when the display device is in the retracted position, the display device is shut down.

According to yet another feature of the invention, preferably the protective system comprises a first electrical circuit and a second electrical circuit which is carried by the breathing mask and connected to the first electrical circuit by the electrical connector.

The weight of the safety device is thus reduced.

According to an additional feature, the first electrical circuit controls the supply of power and/or the electrical protection of the second electrical circuit.

Most of the weight is therefore not supported by the safety device.

Of course the various features, variants, and/or embodiments of the present invention mentioned in the dependent claims may be associated with one another in various combinations to the extent that they are not incompatible with or mutually exclusive of one another.

### BRIEF DESCRIPTION OF DRAWINGS

Other features and advantages of the present invention will become apparent in the following detailed description, referring to the accompanying drawings in which:

FIG. 1 illustrates a perspective view of a protective system according to a first embodiment of the invention,

FIG. 2 illustrates a front view of the protective system according to the first embodiment,

FIG. 3 illustrates a perspective view of a protective system according to a second embodiment of the invention,

FIG. 4 illustrates a side view of the protective system according to the second embodiment,

FIG. 5 illustrates an exploded perspective view, along the arrow denoted V in FIG. 3, of a display device that is part of the protective system according to the second embodiment,

FIG. 6 illustrates a cross-section of the protective system according to the second embodiment, along the line denoted VI-VI in FIG. 3,

FIG. 7 illustrates a perspective view of a protective system according to a third embodiment of the invention,

FIG. 8 illustrates an enlarged view of part of the protective system according to the third embodiment of the invention,

FIG. 9 illustrates the protective system according to the third embodiment with the eye protection separated from the breathing mask,

FIG. 10 illustrates a perspective view of a protective system according to a fourth embodiment of the invention,

FIG. 11 illustrates a front view of the protective system according to the fourth embodiment,

FIG. 12 illustrates a cross-section of the protective system according to the fourth embodiment, along the line denoted XII-XII in FIG. 11,

FIG. 13 illustrates a protective system according to a fifth embodiment of the invention, in an inactive state,

FIG. 14 illustrates the protective system according to the fifth embodiment of the invention, in an active state,

FIG. 15 illustrates an exterior virtual display and a symbol-based display provided to the pilot,

FIG. 16 illustrates only a symbol-based display provided to the pilot,

FIG. 17 schematically represents a protective system arranged in an aircraft cockpit.

### DETAILED DESCRIPTION OF THE INVENTION

Note that in the figures, the structural and/or functional elements common to different embodiments may have the same references. Thus, unless otherwise indicated, such elements have identical structural, dimensional, and material properties.

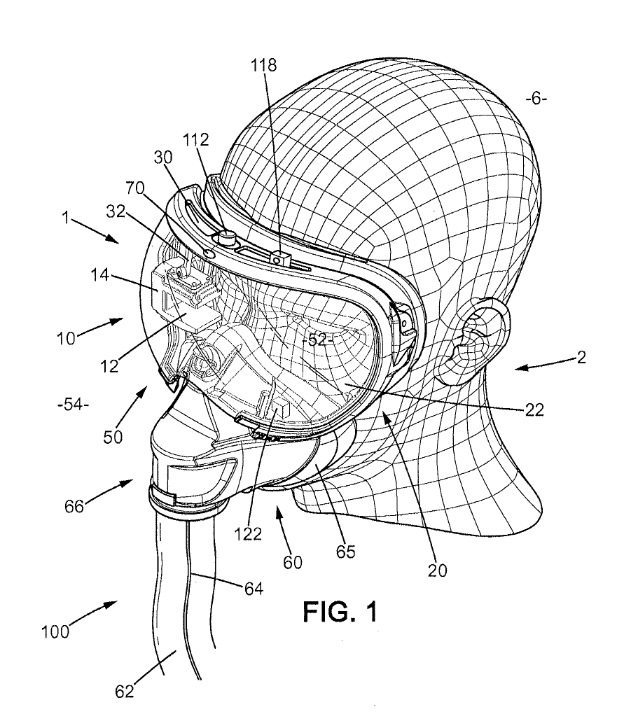

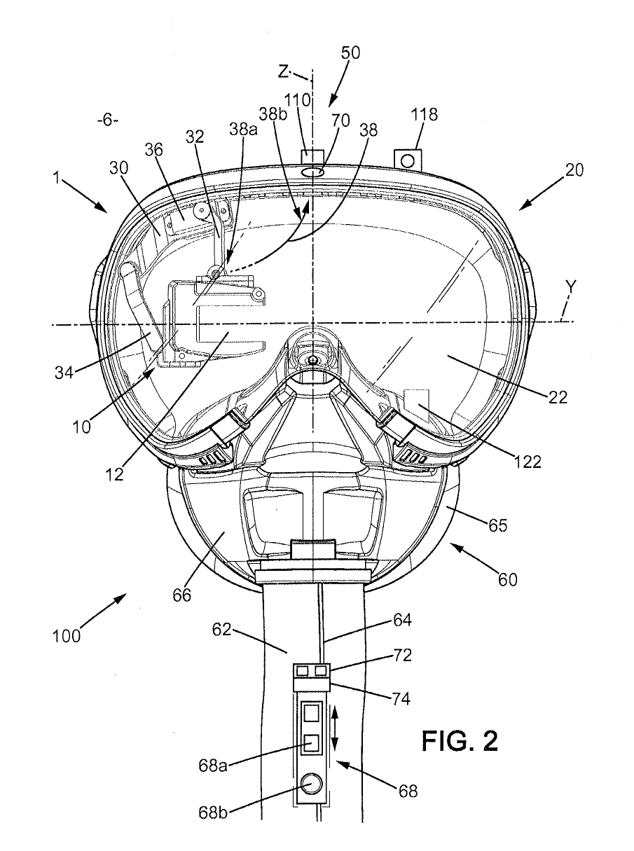

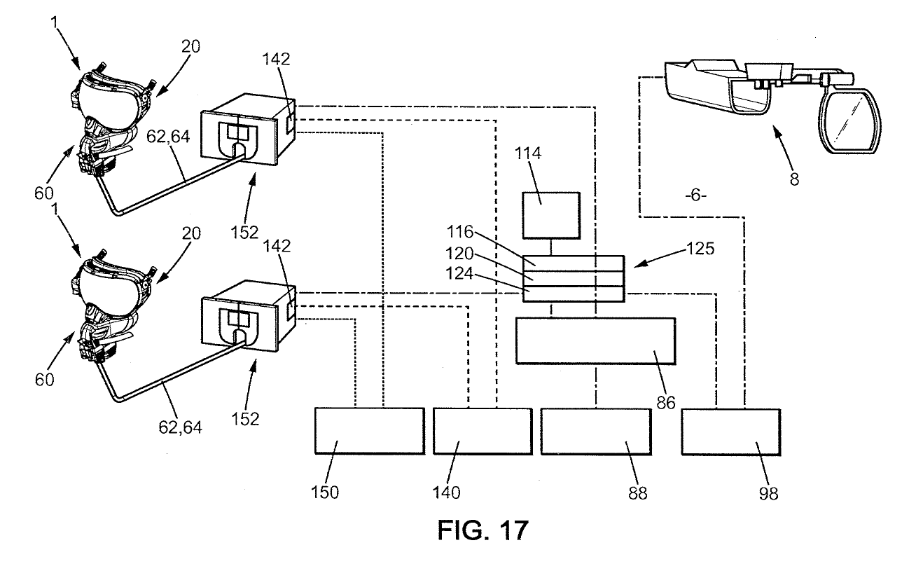

FIGS. 1 and 2 as well as FIG. 17 illustrate a protective system 100 for an aircraft pilot, arranged in an aircraft cockpit 6. The protective system 100 comprises a breathing mask 60 and a protective system 50, for the pilot and co-pilot.

Each breathing mask 60 essentially comprises a facepiece 65, a regulator 66, an oxygen supply duct 62, and an electrical conductor 64.

The oxygen supply duct 62 is connected to a source of oxygen 150 via a storage box 152. The facepiece 65 is intended to be placed in contact with the pilot's face 2, around the nose and mouth. The regulator 66 provides a respiratory gas comprising a mixture of air and oxygen according to the needs of the pilot.

The protective system 50 essentially comprises an eye protection (protective goggles) 20 and a safety device 1. The eye protection 20 comprises a screen (lens) 22, preferably substantially transparent, which lies between the pilot's eyes 4 and an external space 54. More particularly, in the illustrated embodiment, the eye protection 20 is placed against the face 2 of the pilot around the eyes 4, the eye protection 20 isolating an internal space 52 between the eye protection 20 and the pilot's eyes 4.

The safety device 1 essentially comprises a display device 10 and a support 30.

The display device 10 displays information content 95 on a display member 12 formed by a semi-reflective member 12 arranged in front of at least one eye 4 of the pilot. In the first embodiment illustrated in FIGS. 1 and 2, the display device 10 is arranged within the internal space 52. The display device 10 is supported by the support 30 so as to keep the display of information content 95 in front of the pilot's eye 4. In the illustrated embodiment, the support 30 is fixed to the eye protection 20 which is removably attached to the breathing mask 60. The eye protection 20 and the breathing mask 60 are held on the pilot's face 2 by a harness. Alternatively, only the breathing mask 60 or the eye protection 20 is held on the face by the harness.

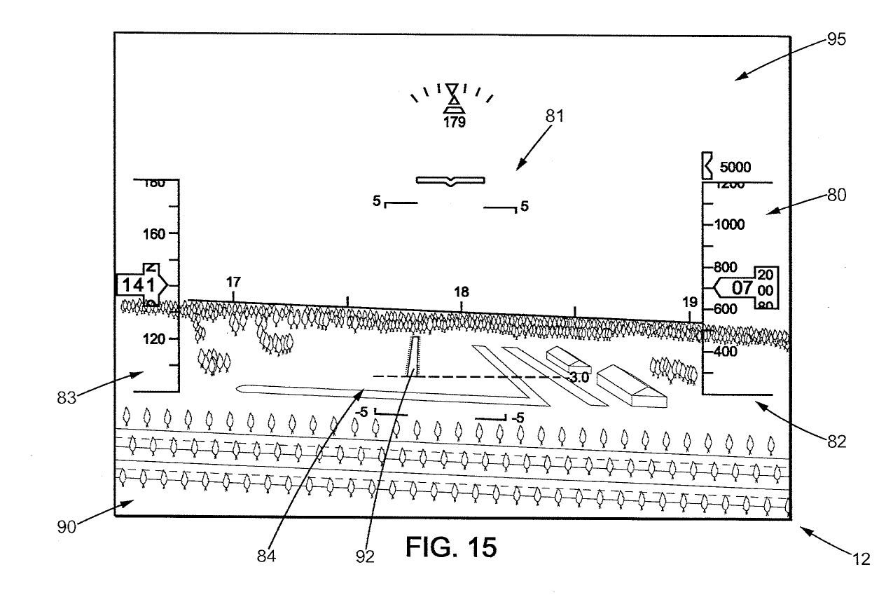

FIG. 15 shows the information content 95 displayed on the display member 12. In the illustrated embodiment, the display device 10 comprises a symbol-based display 80 and an exterior virtual display 90. The exterior virtual display 90 shows a virtual view in the form of video from outside the aircraft, in particular in front of the aircraft, so as to improve the pilot's vision.

The virtual view is provided, preferably to a source of information 98, by an object detector such as preferably an infrared camera, a radar, a multispectral detector, or similar. In FIG. 15, the exterior virtual display 90 displays an airport runway 92.

The symbol-based display 80 shows a symbol-based representation of the flight data obtained from flight instruments 88 and includes an artificial horizon 81, an airspeed indicator 82, an altimeter 83, and a glide path 84 to the runway. The artificial horizon 81, the airspeed indicator 82, and the altimeter 83 constitute essential information content. The glide path 84 is optional information content. The airspeed indicator 82 is preferably composed of an anemometer.

In the illustrated embodiment, the symbol-based display 80 includes a graphics processing device 86 receiving quantitative values from flight instruments 88 and generating its own symbol-based display. Preferably, the flight instruments 88 providing quantitative values to the graphics processing device 86 are the aircraft's flight instruments whose information is displayed on the instrument panel. Alternatively, the symbol-based display 80 could display information from the avionics data bus, or from instruments specific to the protective system 100.

The protective system 100 further comprises a main display device 8 capable of displaying in the aircraft cockpit 6 information content comparable to the information content 95, specifically on the windshield or near the windshield, so that the information content displayed by the main display device 8 is visible to both the pilot and co-pilot. Similarly to display device 10, the main display device 8 is connected to the source of information 98.

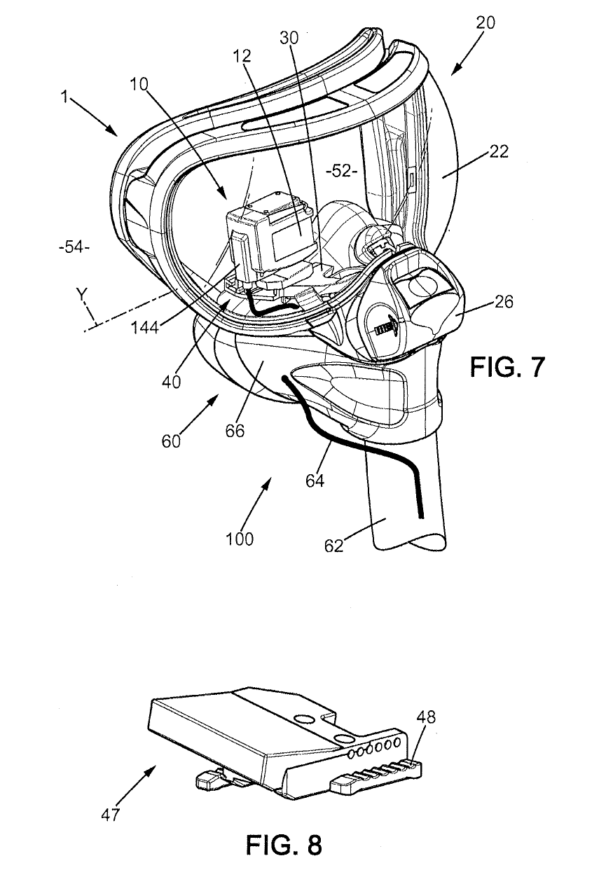

As shown in FIGS. 7 and 17, the protective system comprises a first electrical circuit 142 and an electrical conductor 64. The safety device 10 comprises a second electrical circuit 144 including a circuit board connected to the first electrical circuit 142 by the electrical conductor 64. The first electrical circuit 142 is connected to an electric power source 140 and controls the supply of power and the electrical protection of the second electrical circuit 144.

The protective system 100 further comprises at least one photodiode 70 measuring the ambient light in the aircraft cockpit 6. In the illustrated embodiment, the photodiode 70 is arranged on the eye protection 20. The photodiode 70 is connected to the circuit board. The display device 10 varies the brightness of the information content 95 relative to a display brightness setting, based on the brightness measured by the photodiode 70.

In addition, the protective system 100 comprises a setting adjustment system 72 and a storage system 74. The setting adjustment system 72 allows the pilot to vary the display brightness setting and the storage system saves the display brightness setting so that the display brightness setting is retained even when the display device is turned off. The shape and type of the buttons of the setting adjustment system 72 are chosen to encourage intuitive access without direct visual access to the setting adjustment system 72. In the embodiment illustrated in FIGS. 1 and 2, the setting adjustment system 72 is carried by the oxygen supply duct 62. Alternatively, the setting adjustment system 72 could be arranged on the eye protection 20, the breathing mask 60, or the storage box 152 for the breathing mask.

The protective system 100 further comprises an orientation sensing device comprising a first inertial orientation sensing device 112, a second inertial orientation sensing device 114, a computing device 116, an optical device 118, a optical analysis device 120, an image capture device 122, and a captured image analysis device 124. The image capture device 122 is preferably an infrared system or a camera. As shown in FIG. 17, the computing device 116, the optical analysis device 120, and the captured image analysis device 124 are preferably grouped together in a processing assembly 125.

The first inertial orientation sensing device 112 is tied to the support 30. In the illustrated embodiment, the first inertial orientation sensing device 112 is held on the eye protection 20. The first orientation sensing device 112 detects movements of the display device 10 and in particular of the display member 12 relative to a fixed reference system. The first orientation sensing device 112 is preferably composed of accelerometers and/or a gyroscope detecting the movements of the display device 10 in three perpendicular directions.

The second inertial orientation sensing device 114 is connected to the aircraft cockpit 6. The second orientation sensing device 114 detects movements of the aircraft cockpit 6 relative to a fixed reference system. The second orientation sensing device 114 is preferably composed of accelerometers and/or a gyroscope detecting the movements of the display device 10 in three perpendicular directions.

The first inertial orientation sensing device 112 and the second inertial orientation sensing device 114 are connected to a computing device 116. The computing device 116 determines the movements of the display device 10 relative to the aircraft cockpit 6, in particular the rotational movements of the display device 10 relative to the aircraft cockpit 6, based on information sent to it by the first inertial orientation sensing device 112 and the second inertial orientation sensing device 114.

The optical device 118 is connected to the optical analysis device 120.

The optical device 118 is attached to the support 30. In the illustrated embodiment, the optical device is fixed to the eye protection 20. The optical device 118 captures images in one or several directions and the optical analysis device 120 analyzes the images captured by the optical device 118. The optical analysis device 120 preferably directly determines the position of the display device 10 relative to a reference system tied to the aircraft cockpit 6. Alternatively, the optical analysis device 120 could determine the movements of the display device 10 based on successive images. Characteristic shapes of the aircraft can be used to determine the position of the display device relative to a reference system tied to the aircraft cockpit, but it is preferable to have reference points for this purpose provided in the aircraft cockpit.

Because the first inertial orientation sensing device 112, the second inertial orientation sensing device 114, and the computing device 116 perform the same function as the optical device 118 and the optical analysis device 120, in the invention the first inertial orientation sensing device 112, the second inertial orientation sensing device 114, and the computing device 116 may be omitted, or the optical device 118 and the optical analysis device 120 may be omitted. However, this redundancy is advantageously used to improve the accuracy of determining the position of the display device 10 relative to the aircraft cockpit.

The orientation of the exterior virtual display 90 changes according to the position of the display device 10 relative to the aircraft cockpit 6, so that when the pilot turns his head the contents of the exterior virtual display always appear in the same place in relation to a terrestrial reference.

The image capture device 122 is tied to the support 30. In the illustrated embodiment, the image capture device 122 is fixed to the eye protection 20. The image capture device 122 provides images of the pilot's eye 4 and the captured image analysis device 124 determines the orientation of the pilot's eye 4 in relation to the pilot's face 2.

The captured image analysis device 124 acts on the information content 95.

Thus the captured image analysis device 124 sends a first instruction to turn off the display device 10 when it determines that the pilot is not looking at the information content 95.

The captured image analysis device 124 sends a second instruction to display or remove the optional information content, consisting of the glide path 84 in the illustrated embodiment.

The captured image analysis device 124 sends a third instruction to change the size of the symbol-based display 80 and to display it in the upper portion of the display member 12 when the captured image analysis device determines that the pilot's eye 4 is directed downward with respect to his face.

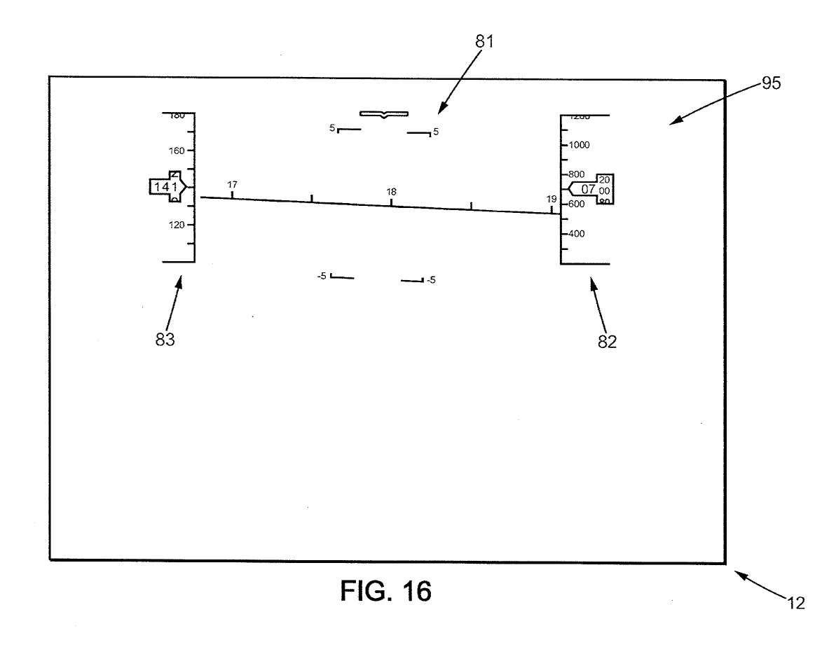

FIG. 16 illustrates information content 95 displayed by the display member 12, which is modified in comparison to the information content 95 illustrated in FIG. 15 in that the exterior virtual display 90 is eliminated and the symbol-based display 80 is reduced in size and shifted to the upper portion of the display member 12.

As shown in FIGS. 1 and 2, the display device 10 is connected to the support 30 by a first connecting rod 32 and a second connecting rod 34. The display device is thus movable between an active position shown in FIGS. 1 and 2 and an inactive position. In the active position 38a, the information content 95 is displayed on the display member 12 substantially in front of the pilot's eye 4, more precisely so that the entire display member 12 is within the field of vision of the pilot's eye 4. The field of vision is defined as a range of 60 degrees to either side (left and right) of a central viewpoint, and to 40 degrees up and 20 degrees down.

In the inactive position 38b, the display device is moved away from the pilot's eye 4, to the top of the eye protection 20 in the embodiment illustrated in FIGS. 1 and 2. In FIG. 2, arrow 38 shows the movement of the display device 10 from the active position 38a to the inactive position 38b.

The protective system 100 comprises a binary movement control 68a with two buttons for controlling the movement of the display device between the active position and the inactive position. The protective system 100 further comprises a substantially proportional adjustment control 68b, by potentiometer or the like. The adjustment control 68b enables adjusting the position of the display device 10 and in particular of the display member 12 in an interpupillary direction Y. In the embodiment illustrated in FIGS. 1 and 2, a motor 36 acts on the first connecting rod 32.

In the first embodiment illustrated in FIGS. 1 and 2, the display device 10 essentially comprises a projector 14 projecting a light beam onto the display member 12. Preferably, the projector comprises an emissive microdisplay.

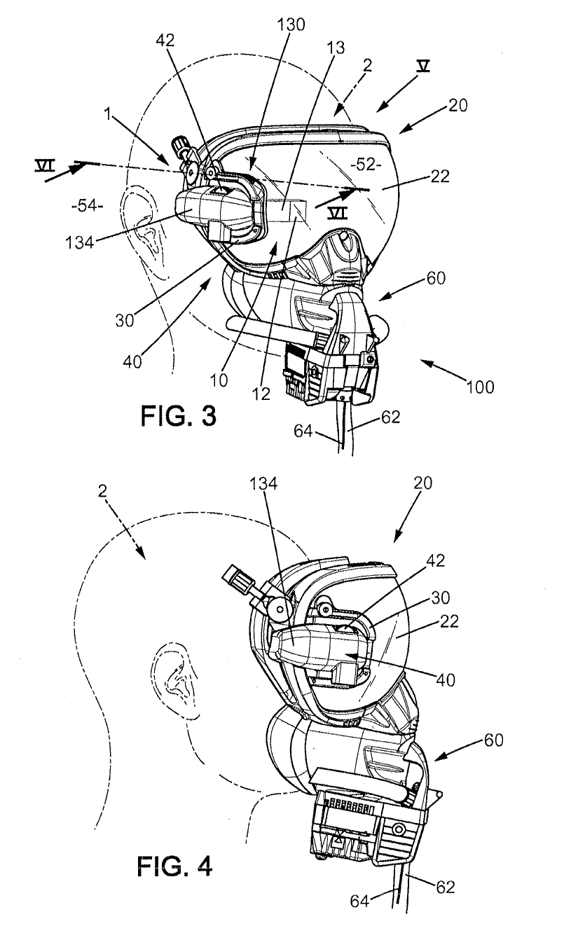

The second embodiment illustrated in FIGS. 3 to 6 essentially differs from the first embodiment illustrated in FIGS. 1 and 2 by the adjustment of the position of the display device 10 and in particular the display member 12 relative to the support 30.

The display device 10 is mounted on the support 30 through an intermediate member 134. An adjustment device 40 allows adjusting the position of the display member 12 with respect to the pilot's eye 4 in the interpupillary direction Y, and an adjustment device 130 allows adjusting the position of the display member 12 relative to the pilot's eye 4 in an elevation direction Z perpendicular to the interpupillary direction and the direction of his gaze. In the embodiment illustrated in FIGS. 3 to 6, the support 30 is fixed on the eye protection 20 and more precisely on the screen 22.

The adjustment device 40 comprises a screw 44 integral to a control knob (wheel) 42 and a threaded portion acting as a nut 46 rigidly fixed to the display device 10. The control knob 42 and the screw 44 are mounted so as to pivot about the interpupillary direction Y relative to the intermediate member 134. Thus, rotation of the control knob 42 causes translational movement of the display member 12 in the interpupillary direction Y. The adjustment device 40 and in particular the screw 44 extends through the screen 22, the control knob being located in the external space 54 and the display device 10 being located in the internal space 52.

The adjustment device 130 comprises an upper guide lug 131, a lower guide lug 132, an upper slot 135, and a lower slot 136. The upper guide lug 131 and the lower guide lug 132 are fixed to the intermediate member 134 and extend in the elevation direction Z. The upper slot 135 and lower slot 136 are formed in the support 30 and have a complementary shape respectively to the upper guide lug 131 and lower guide lug 132. Thus, the upper guide lug 131 is slidably mounted in the upper slot 135 and the lower guide lug 132 is slidably mounted in the lower slot 136 in order to move the intermediate support 134 translationally relative to the support 30 along the elevation direction Z. An indexing hole 137 formed on the support 30 receives a rod, a ball-bearing, or similar element cooperating with the intermediate member 134 to maintain the display member 12 with respect to the pilot's eye 4 in the position desired by the pilot.

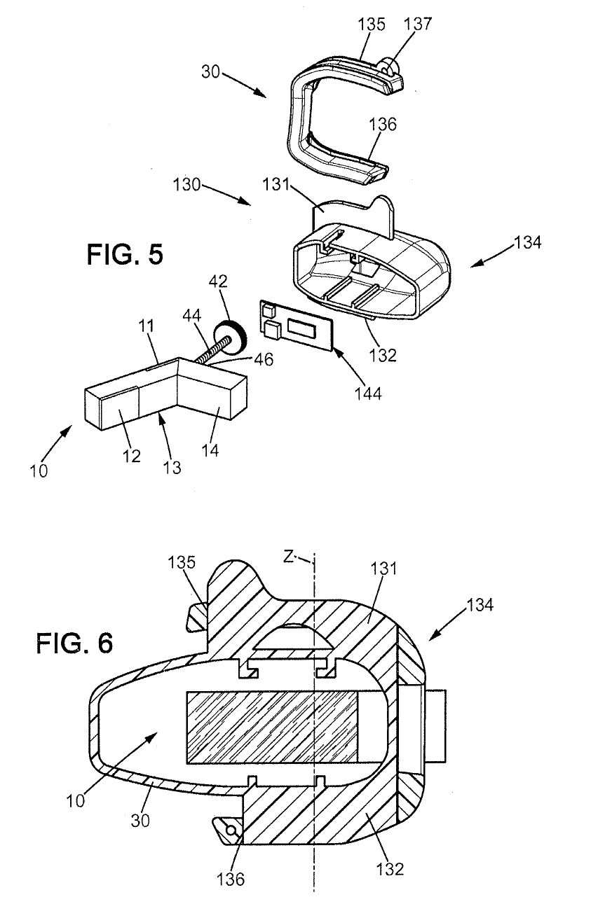

In the embodiment illustrated in particular in FIG. 5, the display device 10 comprises an optical guide 13 including a first element 11 having semi-reflective properties and a second element having semi-reflective properties composed of the display member 12. The projector 14 projects a light beam on the first semi-reflective mirror 11 which is reflected in the direction of the display member 12.

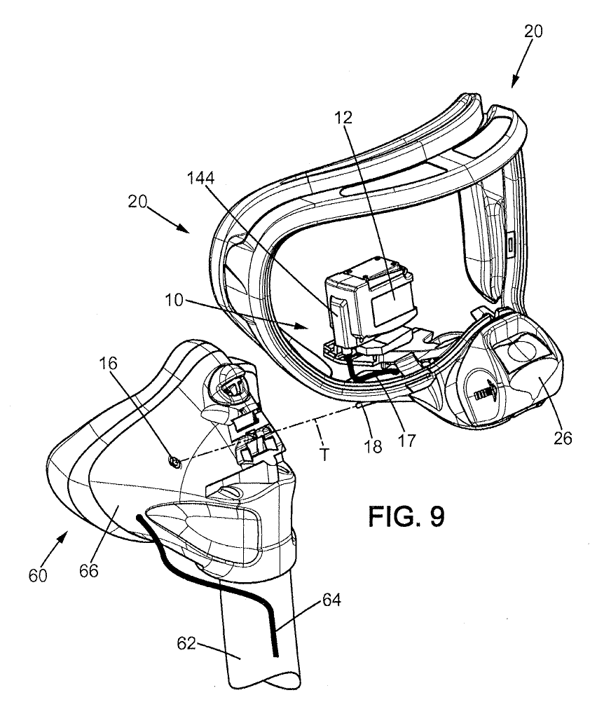

The embodiment illustrated in FIGS. 7 to 9 differs from the embodiment illustrated in FIGS. 1 and 2 by the adjustment of the position of the display device 10 and in particular the display member 12 relative to the support 30 achieved by the adjustment device 40.

In the third embodiment illustrated in FIGS. 7 to 9, the support 30 is fixed to the eye protection 30 and the adjustment device 40 comprises a slide block 47 to which the display device 10 is attached. The slide block is interposed between the support 30 and the display device 10. The display device 10 and in particular the display member 12 can thus move translationally along the interpupillary direction so as to place the display member 12 in front of the pilot's eye 4 and ensure that regardless of the pilot's morphology, his pupil is positioned within the eye-box of the display device. The eye-box is a characteristic of the display device 10. It is the area in which the pupil(s) must be positioned in order for the pilot to see the entire image. The slide block 47 is equipped with a rack 48 enabling the adjustment and maintaining of the desired position.

In addition, FIGS. 7 to 9 illustrate that the eye protection 20 is releasably secured to the breathing mask 60. By pulling on a gripping member 26 of the eye protection 20 in an assembly direction T, the pilot can separate the eye protection 20 from the breathing mask 60. Conversely, by moving the eye protection 20 towards the breathing mask 60, the pilot can reattach the eye protection 20 to the breathing mask 60.

The electrical conductor 64 comprises a first electrical connector 16. The second electrical circuit 144 of the display device 10 is connected to a second electrical connector 18 by an electrical conductor 17. The first electric connector 16 and the second electrical connector 18 are inserted into one another in the assembly direction T in order to interconnect them. Thus, the first electrical connector 16 is automatically electrically connected to the second electrical connector 18 when the eye protection 20 is attached to the breathing mask 60.

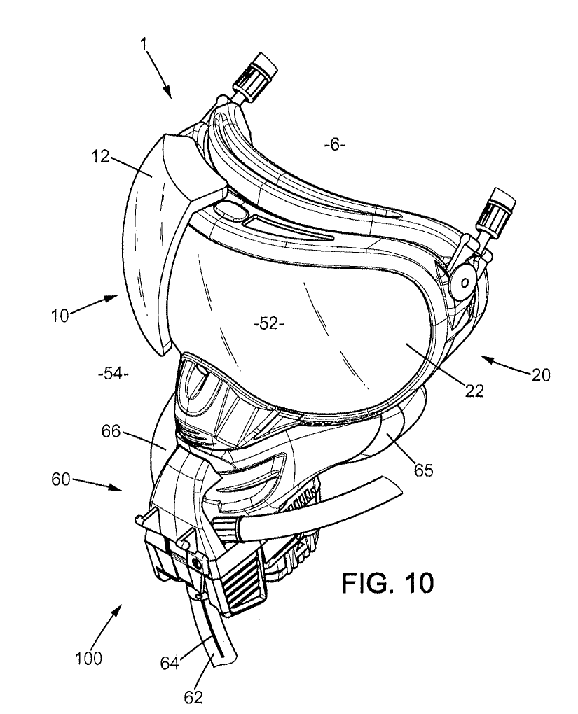

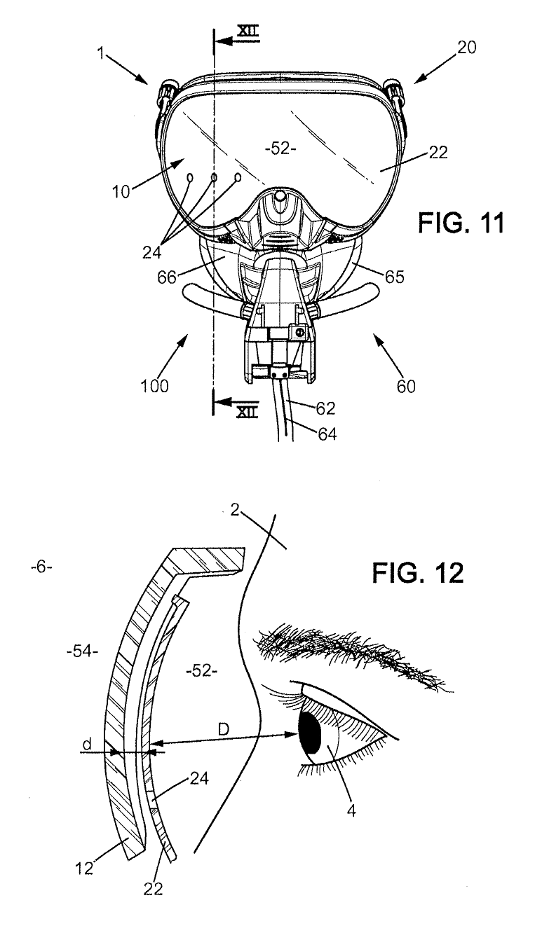

In the fourth embodiment illustrated in FIGS. 10 to 12, the display device 10 is located in the external space 54. The display member 12 is located at a substantially constant distance d from the screen 22. Preferably, the distance d between the display member 12 and the screen 22 is small, preferably less than 10 mm and in particular less than 2 millimeters.

The breathing mask 60 supplies respiratory gas to the internal space 52 and the regulator 66 has a pilot-selectable fire/smoke (emergency) mode with a slight overpressure relative to the ambient pressure in the aircraft cockpit 6. The screen 22 has holes 24 facing the display member 12. A flow of respiratory gas thus circulates through the holes 24 of the internal space 52 toward the external space 54 by passing through the space between the screen 22 and the display member 12.

Each hole 24 has a cross-sectional area. In the embodiment illustrated in FIGS. 10 to 12, the holes 24 are three in number and have the same cross-sectional area. Alternatively, a different number of holes 24 and possibly different cross-sectional areas could be provided. The sum of the cross-sectional areas of the holes 24, called the total cross-sectional area, is preferably between 1 square millimeter and 1 square centimeter.

The pilot's eye 4 is distanced from the screen 22 by an unobstructed distance D that is greater than 18 millimeters, allowing a pair of eyeglasses to be interposed between the pilot's eye and the screen 22.

In the other illustrated embodiments, as the display device 10 is arranged within the internal space 52, the display device is interposed between the screen 22 and the pilot's eye 4 and therefore the unobstructed distance D lies between the pilot's eye 4 and the display device 10.

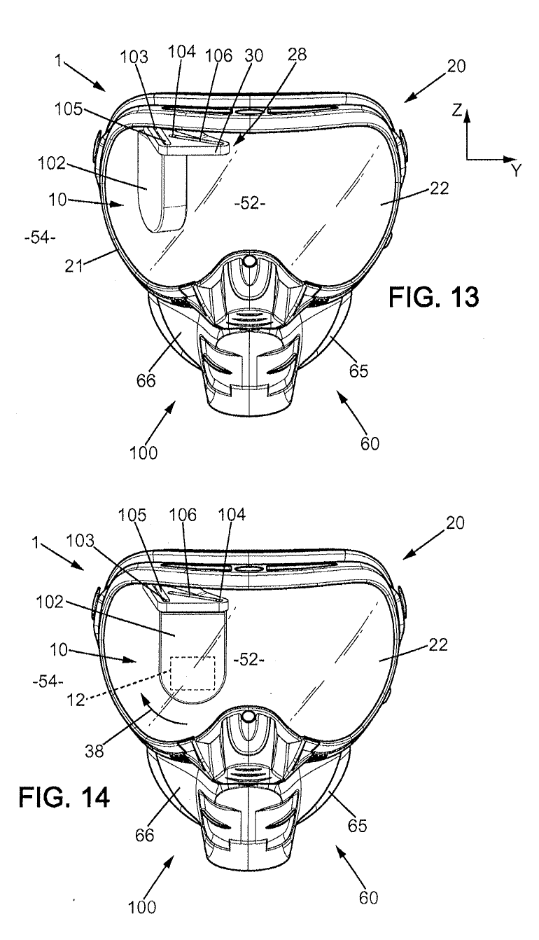

In the fifth embodiment illustrated in FIGS. 13 and 14, the display device 10 is located within the internal space 52 and is mounted on the support 30 through a slide system 28 which moves the display device between the active position and the inactive position, as represented by arrow 38. The display device 10 comprises a housing 102 and the slide system 28 comprises a first pin 103, a second pin 104, a first groove 105, and a second groove 106. The first pin 103 and second pin 104 are fixed to the housing 102 and are respectively received in the first groove 105 and in the second groove 106.

In the fifth embodiment illustrated in FIGS. 13 and 14, the first groove 103 is substantially perpendicular to the interpupillary direction Y and to the elevation direction Z, in other words the first groove extends substantially along the viewing direction. The second groove 106 extends substantially at an angle of 45 degrees with respect to the first groove 105. Thus, in the inactive position shown in FIG. 13, the display device 10 extends substantially along a lateral edge of the eye protection 20 and in particular the display device 10 is offset towards the lateral side 21 of the eye protection 20 relative to the pilot's eye.

Of course, the invention is not limited to the illustrated embodiments provided for indicative but non-limiting purposes. Thus, although in the described protective system 100 the graphics processing device 86, the processing assembly, and the second orientation sensing device 114 provide information for the display device of the pilot and for the device display of the co-pilot, at least one among the graphics processing device 86, the processing assembly, and the second orientation sensing device 114 may be duplicated, in particular for safety reasons.

1. Protective system for an aircraft pilot, comprising:
a breathing mask adapted to supply the pilot with a respiratory gas, wherein said breathing mask comprises an oxygen supply duct intended to be connected to an aircraft cockpit,
eye protection comprising a screen intended to sit between the pilot's eyes and an external space,
a safety device comprising a display device and a support,
the display device is able to display, notably in front of a pilot's eye, information intended to assist in piloting the aircraft, and
the support carries the display device so as to keep the display of information in front of the pilot's eye.

2. Protective system according to claim 1 wherein:
the display device comprises a symbol-based display displaying a symbol-based representation of the flight data obtained from flight instruments, and
the symbol-based display device comprises a graphics processing device adapted to receive quantitative values from flight instruments and to generate its own symbol-based display.

3. Protective system according to claim 2, wherein the symbol-based display displays a symbol-based representation of the flight data obtained from flight instruments, including an artificial horizon, an airspeed indicator, and an altimeter.

4. Protective system according to claim 1, wherein:
the protective system further comprises a photodiode for measuring the ambient brightness,
the display device has a variable display brightness, and
the display brightness of the display device varies according to the ambient brightness measured by the photodiode.

5. Protective system according to claim 4, wherein:
the display device further has a display brightness setting, and
the display brightness of the display device varies according to the display brightness setting and the ambient brightness.

6. Protective system according to claim 5, further comprising a storage system which saves the display brightness setting, the display device having an off state and an on state, and the storage system keeps the display brightness setting saved during both the off state and the on state of the display device.

7. Protective system according to claim 1, wherein:
said display device is an emergency display device,
the protective system further comprises a main display device able to display information on or near an aircraft windshield,
the protective system further comprises a source of information, and
said main display device and said emergency display are both connected to said source of information.

8. Protective system according to claim 1, further comprising an orientation sensing device able to determine the position of the support, and the orientation sensing device acts on the display device.

9. Protective system according to claim 8, wherein the orientation sensing device detects variations in orientation of the support.

10. Protective system according to claim 9, wherein the display device displays information content and varies the orientation of the content relative to the support in a manner corresponding to the variations in orientation of the support.

11. Protective system according to claim 8, wherein the orientation sensing device comprises at least one inertial device.

12. Protective system according to claim 11, wherein the orientation sensing device comprises a first inertial device connected to the support, a second inertial device intended to be connected to the aircraft cockpit, and a computing device to which the first inertial device and the second inertial device are connected, the computing device determining the orientation of the pilot's head based on information sent by the first inertial device and the second inertial device.

13. Protective system according to claim 8, wherein the orientation sensing device comprises at least one optical device and an optical analysis device able to determine movements.

14. Protective system according to claim 8, wherein the orientation sensing device further comprises an image capture device and a captured image analysis device able to determine the direction of the pilot's gaze relative to the support.

15. Protective system according to claim 8, wherein the orientation sensing device is able to issue an instruction to turn off the display device.

16. Protective system according to claim 8, wherein:
the display device displays essential information content and optional information content, and
the orientation sensing device is able to issue an instruction to turn off or to display the optional information content.

17. Protective system according to claim 1, wherein:
the display device comprises a semi-reflective member, and
the display device comprises a projector projecting a light beam onto the semi-reflective member.

18. Protective system according to claim 17, wherein the projector comprises an emissive microdisplay.

19. Protective system according to claim 1, wherein the display device is mounted so as to be movable relative to the support between an active position intended to be in front of a pilot's eye and a retracted position away from the pilot' eye.

20. Protective system according to claim 19, wherein the display device is mounted on the support by means of a slide system for moving the display device between the active position and the retracted position.

21. Protective system according to claim 1, wherein the display device lies in an internal space separated from the external space by the screen.

22. Protective system according to claim 21, wherein the protective assembly further comprises an adjustment device extending through the screen and able to move the display device.

23. Protective system according to claim 21, wherein the display device is adapted to be positioned at a distance of at least 18 millimeters from the pilot's eyes, in order to be compatible with wearing eyeglasses.

24. Protective system according to claim 1, wherein the display device is in the external space, near the screen.

25. Protective system according to claim 24, wherein the screen has a hole or holes facing the display device.

26. Protective system according to claim 25, wherein the hole or holes has (have) a total cross-sectional area of between 1 square millimeter and 1 square centimeter.

27. System according to claim 25, wherein the display device is situated at a distance of less than 10 mm, in particular less than 5 millimeters and preferably less than 2 millimeters, from the protective screen.

28. Protective system according to claim 1, wherein the display device is movably mounted relative to the support so as to move along an interpupillary direction.

29. Protective system according to claim 28, comprising an adjustment device adapted to move the display device translationally along the interpupillary direction.

30. Protective system according to claim 1, wherein the display device is mounted relative to the support so as to be movable along an elevation direction.

31. Protective system according to claim 30, further comprising an adjustment device adapted to move the display device translationally relative to the support, along an elevation direction.

32. Protective system according to claim 1, wherein the eye protection is held in a releasable or retractable manner relative to the breathing mask.

33. Protective system according to claim 1, wherein:
the eye protection is releasably attached to the breathing mask,
the protective system comprises an electrical conductor intended to be connected to the aircraft cockpit,
the electrical conductor comprises a first electrical connector, and
said display device is connected to a second electrical connector,
the first electrical connector is automatically electrically connected to the second electrical connector when the eye protection is attached to the breathing mask.

34. Protective system according to claim 1, comprising a first electrical circuit and a second electrical circuit which is carried by the breathing mask and connected to the first electrical circuit by the electrical connector.

35. Protective system according to claim 34, wherein the first electrical circuit controls the supply of power and/or the electrical protection of the second electrical circuit.
